(19) United States
(12) Patent Application Publication
(10) Pub. No.: US 2026/0080896 A1
(43) Pub. Date: Mar. 19, 2026

(54) WIRELESS DEVICE FINGERPRINTING SYSTEMS AND METHODS

(71) Applicant: Infinitus Holdings Inc., Penn Valley, PA (US)

(72) Inventors: Joshua Ian Cohen, Penn Valley, PA (US); John Cronin, Jericho, VT (US)

(21) Appl. No.: 18/890,430

(22) Filed: Sep. 19, 2024

(51) Int. Cl. G10L 25/84; G10L 17/06

(52) U.S. Cl. CPC G10L 25/84; G10L 17/06

(57) ABSTRACT

A method includes receiving signals, via a phased antenna array, from at least one signal source, wherein the received signals include noise caused, at least in part, by sound waves near the at least one signal source; locating, via a signal processor, the at least one signal source in three-dimensional (3D) space using the received signals; demodulating the noise in the received signals caused by sound waves near the at least one signal source to produce sound data; identifying at least one user from voice data extracted from the sound data and/or at least one device associated with the at least one signal source to produce identification data; and in response to the received signals, the sound data and/or the identification data satisfying one or more rules in a rule database, executing an action associated with the one or more rules.

### FIELD OF THE DISCLOSURE

The present disclosure relates generally 3D mapping using a phased array and more specifically to wireless device fingerprinting systems and methods.

### BACKGROUND

Identification of signal sources and any persons associated with those sources is often based on public facing information such as MAC addresses. This data can be changed and faked and may not be available for every signal emitting device. Allowing devices to broadcast signals while obfuscating their identity.

Personal information about device owners may be encrypted or otherwise obfuscated. This makes it difficult for receiver devices to identify the user of a device or other signal source.

These problems allow bad actors to hide their device activity, conversations, and identity while planning or committing illegal acts or harmful activities. Law enforcement requires a method of identifying these individuals and their plans that doesn't involve decrypting data.

### SUMMARY

The present disclosure solves the foregoing disadvantages with conventional approaches by providing wireless device fingerprinting systems and methods. According to one aspect, a system includes a phased antenna array configured to receive signals from at least one signal source, where the received signals include noise caused, at least in part, by sound waves near the at least one signal source. The system also includes a signal processor configured to locate the at least one signal source in three-dimensional (3D) space using the received signals. The system further includes a sound demodulator configured to demodulate the noise in the received signals caused by sound waves near the at least one signal source to produce sound data. In addition, the system includes at least one processor configured to identify at least one user from voice data extracted from the sound data and/or at least one device associated with the at least one signal source to produce identification data, and, in response to the received signals, the sound data and/or the identification data satisfying one or more rules in a rule database, execute an action associated with the one or more rules.

In some embodiments, the phased antenna array is configured to initially send a ping signal to the at least one signal source.

In some embodiments, the at least one signal source includes one or more of a vibration detector, a passive tag, and/or a user device.

In some embodiments, the vibration detector actively transmits the signals to the phased antenna array without being pinged by the phased antenna array.

In some embodiments, the signal processor is configured to locate the at least one signal source using at least one of an Angle of Arrival (AoA) measurement, a Kalman filter, a Joint Probabilistic Data Association (JPDA) operation, and/or a Multiple Signal Classification (MUSIC) algorithm.

In some embodiments, the signal processor is configured to locate the at least one signal source by triangulation and/or trilateration.

In some embodiments, the one or more rules in the rule database are ordered according to an urgency level and processed in order of the urgency level.

In some embodiments, the at least one of the one or more rules include multiple criteria that must be satisfied in order to execute the associated action.

In some embodiments, at least one rule of the one or more rules specifies that at least one particular word is found in the voice data.

In some embodiments, at least one rule of the one or more rules specifies that an identified user is found in a particular list of users or at least a particular number of devices are detected in a particular area.

According to another aspect, a method includes receiving signals, via a phased antenna array, from at least one signal source, where the received signals include noise caused, at least in part, by sound waves near the at least one signal source. The method also includes locating, via a signal processor, the at least one signal source in three-dimensional (3D) space using the received signals. The method further includes demodulating the noise in the received signals caused by sound waves near the at least one signal source to produce sound data. In addition, the method includes identifying at least one user from voice data extracted from the sound data and/or at least one device associated with the at least one signal source to produce identification data. Further, the method includes, in response to the received signals, the sound data and/or the identification data satisfying one or more rules in a rule database, executing an action associated with the one or more rules.

In some embodiments, the method further includes an initial step of sending, via the phased antenna array, a ping signal to the at least one signal source.

In some embodiments, the at least one signal source includes one or more of a vibration detector, a passive tag, and/or a user device.

In some embodiments, the vibration detector actively transmits the signals to the phased antenna array without being pinged by the phased antenna array.

In some embodiments, locating includes locating the at least one signal source using at least one of an Angle of Arrival (AoA) measurement, a Kalman filter, a Joint Probabilistic Data Association (JPDA) operation, and/or a Multiple Signal Classification (MUSIC) algorithm.

In some embodiments, locating includes locating the at least one signal source by triangulation and/or trilateration.

In some embodiments, the method further includes ordering the one or more rules in the rule database according to an urgency level; and processing the one or more rules in order of the urgency level.

In some embodiments, at least one of the one or more rules include multiple criteria that must be satisfied in order to execute the associated action.

In some embodiments, at least one rule of the one or more rules specifies that at least one particular word is found in the voice data.

In some embodiments, at least one rule of the one or more rules specifies that an identified user is specified in a particular list of users or at least a particular number of devices are detected in a particular area.

### BRIEF DESCRIPTION OF THE DRAWINGS

FIG. 1 is a schematic diagram of a phased array tracking system, according to an embodiment.

FIG. 2 is a flowchart of a method performed by a Base Module, according to an embodiment.

FIG. 3 is a flowchart of a method performed by a Signal Processing Module, according to an embodiment.

FIG. 4 is a flowchart of a method performed by a Sound Demodulation Module, according to an embodiment.

FIG. 5 is a flowchart of a method performed by an Admin Module, according to an embodiment.

FIG. 6 is a flowchart of a method performed by an Identification Module, according to an embodiment.

FIG. 7 is a flowchart of a method performed by a Voiceprint Module, according to an embodiment.

FIG. 8 is a flowchart of a method performed by an Action Module, according to an embodiment.

FIG. 9 is a flowchart of a method performed by a Rules Database, according to an embodiment.

FIG. 10 is a flowchart of a method performed by a User Database, according to an embodiment.

### DETAILED DESCRIPTION

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

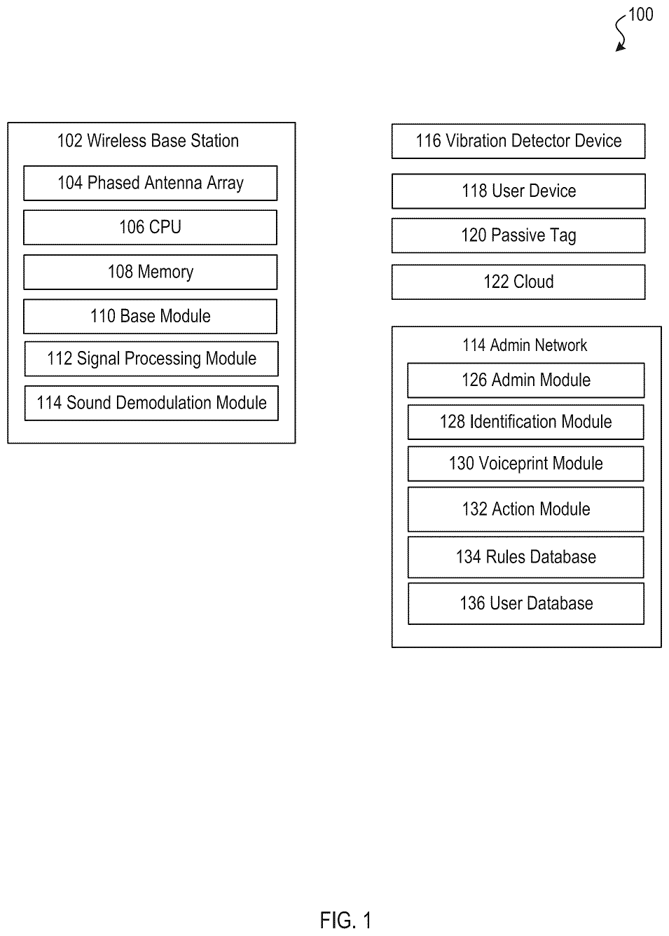

FIG. 1 is a schematic illustration of a phased array tracking system 100 (or “system 100”). The system 100 may include a wireless base station 102, which may track the location of one or more signal sources. The wireless base station 102 may include a phased antenna array 104 comprised of multiple individual antennas, each capable of transmitting and/or receiving electromagnetic signals. The wireless base station 102 receives signals from one or more sources using the phased antenna array 104. It triangulates the location of the source using an angle of arrival (AoA) calculation based on the difference in phase and time of the received signals. The wireless base station 102 may have active and passive functionality, which may be separate modes or may both function simultaneously. Passive functionality may refer to only receiving signals from sources, whereas active functionality may refer to transmitting to a device in order to elicit a response.

The system 100 may further include a phased antenna array 104, which may be an array of antennas that receive and/or transmit at different phases. This phased array 104 may include any combination of receiver antennas, transmitter antennas, and antennas capable of both receiving and transmitting signals, thereby providing versatile communication capabilities. The phased antenna array 104 may include at least one antenna capable of transmission for the active functions of the wireless base station 102, such as beamforming, signal amplification, and directed communication. The phased antenna array 104 may also include at least two antennas capable of receiving for the triangulation functions of the wireless base station 102. These receiving antennas facilitate precise location determination of signal sources through techniques such as angle of arrival (AoA) estimation. The antennas may be arranged in a specific geometric configuration, such as linear, circular, or planar arrays, and electronically connected such that their signal phases and amplitudes can be controlled. This electronic control enables the phased array to dynamically steer the beam direction, enhance signal strength, and reduce interference from unwanted sources. The phased antenna array 104 may incorporate signal processing algorithms to optimize its performance. These algorithms may include adaptive beamforming, which adjusts the phase and amplitude of each antenna element to maximize signal reception from desired directions while minimizing noise and interference. The phased antenna array 104 may also support multiple-input multiple-output (MIMO) technology, allowing simultaneous transmission and reception of multiple data streams, thereby increasing the overall data throughput and reliability of the system 100. The phased antenna array 104 may be integrated with a control unit that monitors and adjusts the operational parameters of each antenna element in real-time. This control unit may utilize feedback mechanisms to dynamically adapt to changing environmental conditions and signal propagation characteristics, ensuring optimal performance under various scenarios. The integration of these features within the phased antenna array 104 enhances the system's capability to provide robust and efficient communication and precise triangulation of signal sources. The phased antenna array 104 may include a low noise amplifier (LNA) to amplify weak incoming signals from multiple antennas while minimizing noise. The LNA may include a number of channels which each correspond to a specific antenna in the phased array, enhancing sensitivity and accuracy.

The system 100 may further include a computer processing unit (CPU) 106, which may be configured to decode and execute any instructions received from one or more other electronic devices or server(s). The CPU 106 may include one or more general-purpose processors (e.g., INTEL® or Advanced Micro Devices® (AMD) microprocessors) and/or one or more special purpose processors (e.g., digital signal processors or Xilinx® System On Chip (SOC) Field Programmable Gate Array (FPGA) processor). The CPU 106 may be configured to execute one or more computer-readable program instructions, such as program instructions, to carry out any of the functions described in this description.

The system 100 may further include memory 108, which may include but is not limited to, fixed (hard) drives, magnetic tape, floppy diskettes, optical disks, Compact Disc Read-Only Memories (CD-ROMs), and magneto-optical disks, semiconductor memories, such as ROMs, Random Access Memories (RAMs), Programmable Read-Only Memories (PROMs), Erasable PROMs (EPROMs), Electrically Erasable PROMs (EEPROMs), flash memory, magnetic or optical cards, or another type of media/machine-readable medium suitable for storing electronic instructions. The memory may include modules implemented as a program.

The system 100 may further include a base module 110, which may continuously collect data from the phased antenna array 104. The base module 110 may initiate the signal processing module 112 to process the received signals. After signal processing, the base module 110 may initiate the sound demodulation module 114 to demodulate the noise in the signal caused by sound waves near the antenna. This noise may then be converted back into sound.

The system 100 may further include a signal processing module 112, which may process the signals received by the phased antenna array 104 in order to locate the source of the signal in 3-dimensional space. The signal processing module may utilize sophisticated computational techniques such as Kalman filters and joint probabilistic data association to accurately estimate device locations and track their movements while maintaining synchronization among multiple antennas for precise triangulation. The signal processing module 112 may utilize a subnanosecond clock and a high-speed power meter for detecting the small differences in time between receiving a signal at two or more receiver antennas.

The system 100 may further include a sound demodulation module 114, which may demodulate the signals received by the phased antenna array 104 in order to extract sound information. Demodulation techniques are used to extract the original sound vibrations from the modulated electromagnetic signal. Several demodulation methods can be applied, depending on the nature of the modulation and the characteristics of the received signal, such as Fourier Analysis, Interferometry, Phase-Locked Loop, etc. The demodulated signal is used to reconstruct the sound waves, which can then be played back or analyzed.

The system 100 may further include a vibration detector device 116, which may be a device that transmits electromagnetic signals and is designed to be extremely sensitive to vibrations, such as those caused by sound waves. The vibration detector device 116 may utilize the piezoelectric effect or MEMS technology to detect minute vibrations caused by voice. The vibration detector device 116 may be most sensitive to the frequency range of human speech (approximately 300 Hz to 3400 Hz).

The system 100 may further include a user device 118, such as a laptop, smartphone, tablet, computer, smart speaker, or any other device capable of transmitting electromagnetic signals.

The system 100 may further include a passive tag 120, which may be a passive device that modulates an active signal from the phased antenna array 104 and is highly sensitive to vibrations from sound waves. For example, passive RFID tags that can detect minute vibrations caused by voice.

In some embodiments, a user device, such as a mobile phone, will transmit on its own without prompting and the phased array antenna 104 of the wireless base station 102 will passively collect the signals and demodulate the vibrations/sound in the ambient environment to identify a voice for fingerprinting the mobile phone. In some embodiments the phased array antenna 104 of the wireless base station 102 will actively transmit to the mobile phone prompting it to transmit more signals or bouncing a constant stream of signals off the antenna in the phone enabling a much larger sample of data to reconstruct significantly more sound from the ambient environment.

The system 100 may further include a cloud 122 or communication network may be a wired and/or a wireless network. The communication network, if wireless, may be implemented using communication techniques such as Visible Light Communication (VLC), Worldwide Interoperability for Microwave Access (WiMAX), Long Term Evolution (LTE), Wireless Local Area Network (WLAN), Infrared (IR) communication, Public Switched Telephone Network (PSTN), Radio waves, and other communication techniques known in the art. The communication network may allow ubiquitous access to shared pools of configurable system resources and higher-level services that can be rapidly provisioned with minimal management effort, often over the Internet, and relies on the sharing of resources to achieve coherence and economies of scale, like a public utility. At the same time, third-party clouds enable organizations to focus on their core businesses instead of expending resources on computer infrastructure and maintenance.

The system 100 may further include an admin network 124, which may be a computer or network of computers that may receive data from the wireless base station 102 via the cloud 122. In some embodiments, some or all of the functions of the admin network 124 may be performed locally on the wireless base station 102.

The system 100 may further include an admin module 126, which may receive signal data and sound data from the base module 110. The admin module 126 may then initiate the identification module 128 to identify signal sources and/or users. If there is a detected voice in the sound data, the admin module 126 may initiate the voiceprint module 130 to create or update a voiceprint in the user database 136 from the voice data. The admin module 126 may then initiate the action module 132 to take any actions specified by the rules in the rules database 134.

The system 100 may further include an identification module 128, which may attempt to identify a signal source and/or user. In many cases, the signal source can be identified by an IP or MAC address, but these can be hidden or changed. Further, some signal sources may not have identifying information embedded in their signal. The identification module 128 may use tracking data to estimate the positions of signal sources based on their last known position and trajectory in order to identify a new signal source as the same signal source detected earlier. The identification module 128 may use voice print data to identify the user of a user device 118.

The system 100 may further include a voiceprint module 130, which may generate or update a user's voiceprint. The admin module 126 may then store that voiceprint in the user database 136. This voiceprint can then be referenced later by the identification module 128 to identify a user based on their voice.

The system 100 may further include an action module 132, which may take some action based on the signal data from the signal processing module 112, sound data from the sound demodulation module 114, and identification data from the identification module 128. These sets of data are compared to the rules database 134 to determine if an action should be taken. If so, the action module 132 executes the corresponding actions.

The system 100 may further include a rules database 134, which may contain rules on when the action module 132 should execute an action. Each rule may contain parameters pertaining to the features of the signal data, sounds or words extracted from the sound data, and/or the identity of the signal source and/or user.

The system 100 may further include a user database 136, which may contain data specific to each user. Users may refer to any person for whom the system 100 has generated a voiceprint or any person whose identity is associated with a signal source. The data in the user database 136 may include the user's voiceprint, associated user device 118, any signal source where the user's voice was detected, personal data on the user, or any other data specific to a user.

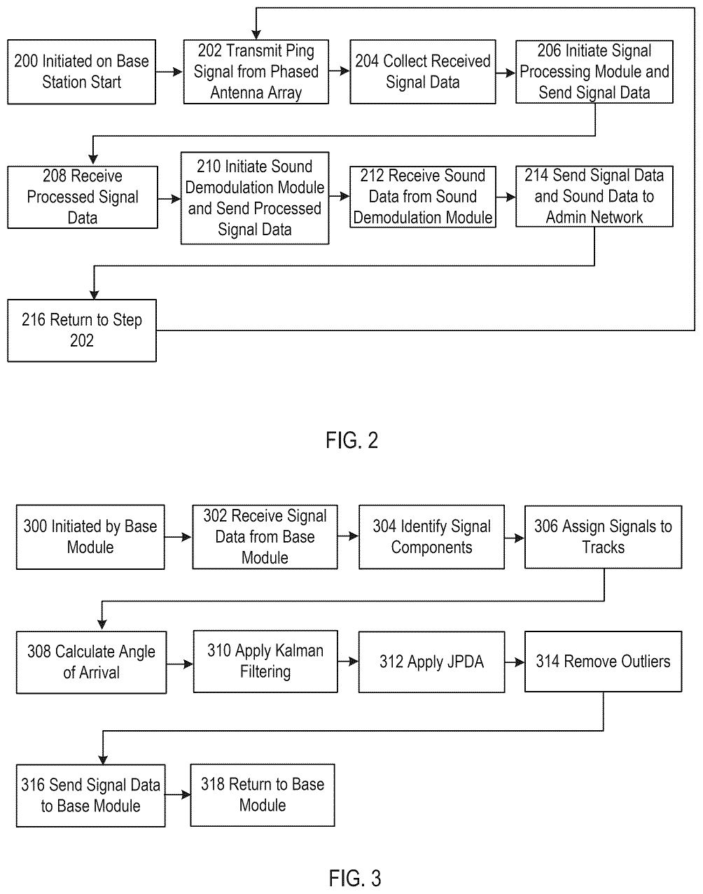

FIG. 2 illustrates an example operation of the base module 110. The base module 110 may be initiated at step 200 when the wireless base station 102 is powered on and/or activated. The base module 110 may transmit at step 202 a signal from the phased antenna array 104 in order to ping any passive tags 120 or other passive devices. Passive devices, such as the passive tags 120, do not constantly transmit signals, and may first receive a signal from the phased antenna array 104 in order to be detected. The base module 110 may collect at step 204 received signal data from the phased antenna array 104. Signal data may be data on signals received from one or more sources, such as a vibration detector device 116, user device 118, or passive tag 120. Signal data may include the waveform of the signal, the time received, the intensity of the signal, the phase of the signal, or any other property of the signal. Each antenna of the phased antenna array 104 may provide unique signal data. The base module 110 may initiate at step 206 the signal processing module 112 and send in the signal data. The signal processing module 112 may process the signals received by the phased antenna array 104 in order to locate the source of the signal in 3-dimensional space. The signal processing module 112 may utilize sophisticated computational techniques such as Kalman filters and joint probabilistic data association to accurately estimate device locations and track their movements while maintaining synchronization among multiple antennas for precise triangulation. The signal processing module 112 may utilize a subnanosecond clock and a high-speed power meter for detecting the small differences in time between receiving a signal at two or more receiver antennas. The base module 110 may receive at step 208 processed signal data from the signal processing module 112. The signal data may include tracking data. This tracking data may include the calculated location of each signal source based on received signals. The data may also include metadata such as confidence level and margin of error. For example, the tracking data may include that a user's laptop is at the coordinates (1348 cm, 804 cm, −52 cm) and a passive tag 120 is at the coordinates (1145 m, 210 cm, −30 cm) where the origin (0,0,0) is the location of the wireless base station 102. The signal may also include component data. This component data may include the identified components of the signal. For example, the signal from a user's laptop may include a carrier frequency at 2.4 GHz and a quadrature amplitude modulation data component. In contrast, the signal from a passive tag 120 may include a carrier frequency of 13.56 MHz and a phase-jitter modulation data component. The base module 110 may initiate at step 210 the sound demodulation module 114 and send in the processed signal data. The sound demodulation module 114 may demodulate the signals received by the phased antenna array 104 in order to extract sound information. Using the component data, the identified components of the signal can be decoupled from the sound frequencies. The base module 110 may receive at step 212 sound data from the sound demodulation module 114. Sound data may refer to the sound signal and/or sounds extracted from the received signals. For example, sound data may be the sound waves of the ambient sounds near a vibration detection device 116 or the sounds of a phone conversation that a person made using their smartphone. The base module 110 may send at step 214 the processed signal data and the sound data to the admin module 126 on the admin network 124. This data may be sent via the cloud 122. The base module 110 may return from step 216 to step 202. The base module 110 may continuously loop as long as the wireless base station 102 is powered and/or active. In some loops, steps may be skipped to save power. For example, the ping signal may not be transmitted in each loop but instead once every minute.

FIG. 3 illustrates an example operation of the signal processing module 112. The signal processing module 112 may be initiated at step 300 by the base module 110. The signal processing module 112 may receive at step 302 signal data from the base module 110. The signal processing module 112 may identify at step 304 the components of the received signals. Identifying the components of a signal, such as a Wi-Fi signal, may involve various techniques and tools. The signal processing module 112 may perform a frequency domain analysis using a Fast Fourier Transform (FFT). This converts the time-domain signal into its frequency components, allowing it to identify the carrier frequencies and any subcarriers. Tools like spectrum analyzers or SDR software can facilitate this process. The signal processing module 112 may determine the modulation scheme used. Wi-Fi signals typically use Orthogonal Frequency Division Multiplexing (OFDM). Analyzing the signal's modulation involves examining the changes in amplitude, frequency, or phase that encode the data. This can be done using constellation diagrams and demodulation algorithms. The signal processing module 112 may decode the higher-level protocol information. Wi-Fi signals conform to standards such as IEEE 802.11. Protocol analyzers or Wi-Fi sniffers can be used to interpret the protocol layers, extracting, such as, without limitation, Media Access Control (MAC) addresses, device names, Internet Protocol (IP) addresses, Service Set Identifiers (SSIDs), network names of all previously connected SSIDs, SSID lengths of all previously connected SSIDs, currently connected SSID, SSID length of currently connected SSID, supported link speeds, supported ciphers and cryptographic capabilities, high throughput capabilities (HT), Aggregated MAC Protocol Data Unit (AMPDU) data, vendor specific capabilities, timestamps for when the probe request was received, signal strengths, signal levels, noise ratios, vendor information, and all other possible information that can be extracted from the signal including but not limited to extracted data and metadata. Artificial Intelligence (AD) and/or machine learning (ML) may be employed to maximize data extraction and understanding. Note that, in some embodiments, decryption of the data is not required for the data components to be identified. The signal processing module 112 may assign at step 306 the signals to tracks, associating new signals with existing tracks or creating new tracks. This involves analyzing the signal data and determining which signals correspond to which tracked signal source. The signal processing module 112 may use criteria such as signal strength, frequency, phase, identifying data, and timing information to match signals to known tracks. If a signal does not match any existing track, a new track is created. This step is crucial for organizing the signal data into coherent tracks that can be further analyzed and monitored. The signal processing module 112 may calculate at step 308 the angle of arrival (AoA) for each signal using phase and time delay data. This involves determining the direction from which each signal is arriving relative to the phased array. The signal processing module 112 may use the phase differences and time delays between the signals received at different antennas to calculate the AoA. This step is useful for understanding the spatial orientation of the signal sources and is a component in triangulating their positions in some embodiments. For example, the signal data indicates that a 2.4 GHz signal was received at antennas 1 and 2 of the phased antenna array 104. The signal was received 3 nanoseconds later at antenna 2, and the phase was shifted by 1 radian. Assume the antennas are 10 cm apart. The path difference (Δd) can be calculated using the time delay using the equation Δd=c×Δt, where c is the speed of light in air. For a Δt value of 3 nanoseconds, the path difference is 9 cm. The sine function of the AoA is equal to the path difference over the antenna separation, sin (AoA)=Δd/d. Evaluating this for a path distance of 9 cm gives an AoA of approximately 1.12 radians. For another example, the signal data indicates that a 2.4 GHz signal was received by antennas 3 and 4 of the phased antenna array 104. The signal was received 2 nanoseconds later at antenna 4, and the phase was shifted by 1 radian. Assume the antennas are 10 cm apart. The phase difference (Δφ) can be converted to path difference (Δd) using Δd=(Δφ·λ)/2π. Where λ is the wavelength. Wavelength can be calculated from (λ)=c/f, where c is the speed of light and f is frequency. Since the frequency is 2.4 GHz, the wavelength is 12.5 cm. Plugging in the wavelength and phase difference gives a path difference of about 2 cm. The sine function of the AoA is equal to the path difference over the antenna separation, sin (AoA)=Δd/d. Evaluating this for a path distance of 2 cm gives an AoA of approximately 0.20 radians. Using multiple methods of calculating the AoA allows the signal processing module 112 to check if all methods agree and, if not, to pick the most reliable method or approximate a value based on the answers of each method. The signal processing module 112 may apply at step 310 Kalman filtering to predict and update the state of tracked objects. The Kalman filter uses a series of measurements observed over time, containing statistical noise and other inaccuracies, to produce estimates of unknown variables. It operates in a two-step process: prediction and update. During the prediction step, the Kalman filter uses the current state estimate to predict the state at the next time step. During the update step, the filter incorporates new measurements to correct the state estimate. This process helps to smooth out the tracking data and provides more accurate estimates of the positions and velocities of tracked objects. The signal processing module 112 may apply at step 312 Joint Probabilistic Data Association (JPDA) to associate measurements with tracks probabilistically. JPDA is used in scenarios where there are multiple potential targets and measurements, and it is not clear which measurement corresponds to which target. The signal processing module 112 may calculate the probabilities of each measurement being associated with each track and update the tracks based on these probabilities. This method helps to resolve ambiguities and improves the accuracy of tracking in complex environments with multiple signal sources. The signal processing module 112 may remove at step 314 outliers to ensure the accuracy of the tracking data. Outliers are measurements that deviate significantly from the expected values and can distort the tracking results. The signal processing module 112 may use statistical analysis and predefined thresholds to identify and filter out these erroneous data points. By removing outliers, the system 100 improves the reliability and precision of the tracking data, ensuring that accurate and consistent measurements are used in the final tracking calculations. The signal processing module 112 may send at step 316 the finalized signal data to the base module 110. The signal data may include tracking data. This tracking data may include the calculated location of each signal source based on received signals. The data may also include metadata such as confidence level and margin of error. For example, the tracking data may include that a user's laptop is at the coordinates (1348 cm, 804 cm, −52 cm) and a passive tag 120 is at the coordinates (1145 m, 210 cm, −30 cm) where the origin (0,0,0) is the location of the wireless base station 102. The signal may also include component data. This component data may include the identified components of the signal. For example, the signal from a user's laptop may include a carrier frequency at 2.4 GHz and a quadrature amplitude modulation data component. In contrast, the signal from a passive tag 120 may include a carrier frequency of 13.56 MHz and a phase-jitter modulation data component. The signal processing module 112 may return at step 318 to the base module 110.

In addition, or alternatively, the signal processing module 112 may use received signal strength to perform trilateration. Trilateration is an alternative method of determining the position of a signal source by calculating the distances between the source and multiple receiving antennas. Distance estimation can be performed using Angle of Arrival (AoA) data, where known positions of the antennas and the angles of the incoming signal are used to infer the distance. However, a more direct and sometimes more precise method may involve deriving the distance from the difference in signal strength received at two or more antennas. The principle behind this method is based on the inverse relationship between signal strength and distance. As the distance from the signal source to the antenna increases, the signal strength decreases, typically following an inverse-square law or a similar attenuation model depending on the environment. In scenarios where trilateration is implemented, the base station 102 may use at least three antennas to determine the exact location of the signal source. The use of three antennas allows the formation of three independent distance equations, which, when solved simultaneously, may provide a unique intersection point corresponding to the location of the signal source. The received signal strength at each antenna may provide the basis for calculating the respective distances. For example, if the signal at one antenna is stronger by a known percentage compared to another, the ratio of these signal strengths can be used to infer the ratio of the distances. By combining this information with the known physical separation between the antennas, the system 100 can establish a set of nonlinear equations representing the distances from the source to each antenna. The solution involves finding the point where the calculated distances (based on signal strength differences) intersect, which represents the most likely location of the signal source relative to the antenna array. Furthermore, the accuracy of trilateration can be enhanced by incorporating additional antennas, which provide more distance measurements and, consequently, reduce the uncertainty in the position estimate. The use of more antennas allows for the implementation of overdetermined systems, where the additional data can be used to minimize errors and improve the robustness of the location estimation process. Trilateration is particularly advantageous in environments where the AoA measurement might be challenging due to multipath propagation or other interference effects that distort the apparent AoA. Trilateration may be used in place of or in conjunction with triangulation.

In some embodiments, the signal processing module 112 uses a MUSIC (Multiple Signal Classification) algorithm. MUSIC utilizes the eigenvalues and eigenvectors of the covariance matrix of the received signal to estimate AoA with high resolution by searching for peaks in the spatial spectrum. To address complex environments, a Multiple Signal Classification (MUSIC) algorithm can be used. In signal processing problems, the objective is to estimate from past measurements or expectations of measurements from a set of constant values upon which the received signals depend.

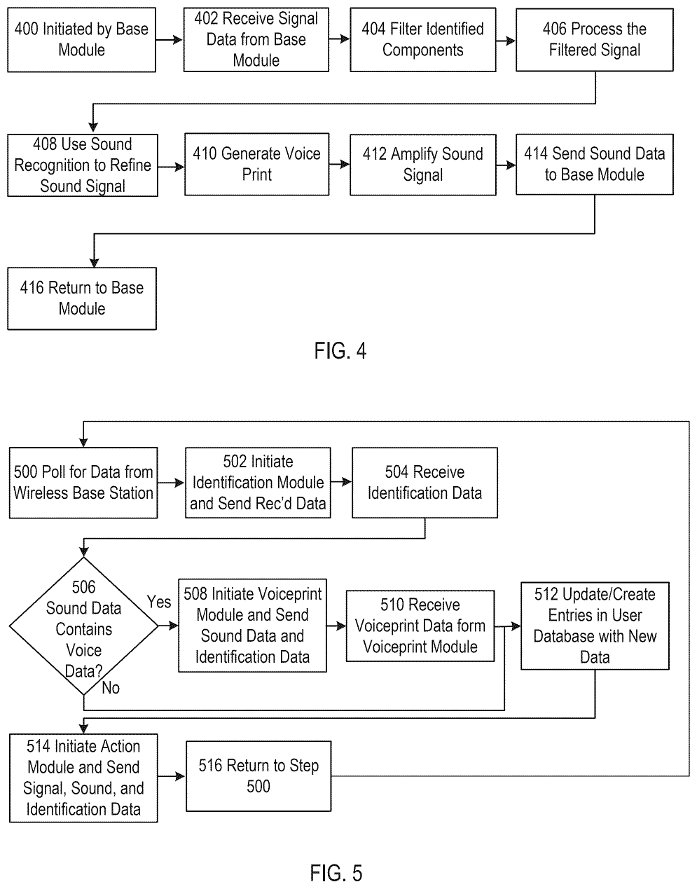

FIG. 4 illustrates an example operation of the sound demodulation module 114. The sound demodulation module 114 may be initiated at step 400 by the base module 110. The sound demodulation module 114 may receive at step 402 the processed signal data from the base module 110. The sound demodulation module 114 may filter at step 404 the identified components of the signal. For example, a bandpass filter may be used to filter out the 2.4 GHz carrier signal from a Wi-Fi signal. Once the identified components of the signal are removed, the remaining signal may contain only the sound signal and any other noise common to electromagnetic signals. The sound signal modulates the original electromagnetic signal via the Doppler effect. The movement of the antenna of the signal source due to vibration from sound causes small changes in the frequency and/or amplitude of the signal. By removing the identified components of the signal, the sound at the source of the signal can be reconstructed. The sound demodulation module 114 may process at step 406 the filtered signal to isolate the sound signal from any other noise in the original signal. This may involve methods such as independent component analysis, fast Fourier transform, low-pass filtering, digital signal processing, or any other method of signal processing that would serve to isolate the sound signal or reduce the noise in the filtered signal. The sound demodulation module 114 may use at step 408 sound recognition algorithms to identify sounds in the signal. These algorithms may use AI or machine learning to identify common sounds. For example, voice recognition software may be used to detect spoken words in the sound signal. This step allows the sound detection module 114 to further isolate the sound signal from other noise in the filtered signal. This step may also be useful for automatically detecting words or phrases of interest. The sound demodulation module 114 may generate at step 410 a voice print from the identified sound signal if the sound contains a voice. Certain characteristics of the voice, known as features, are extracted from the sound signal. Common features include Mel-Frequency Cepstral Coefficients (MFCCs), Linear Predictive Coding (LPC) coefficients, and formant frequencies. These features capture the unique spectral properties of the speaker's voice. The extracted features are then used to create a voice print, a unique digital representation of the speaker's voice. This process involves mapping the features into a high-dimensional feature space where the voice print can be uniquely identified. The created voice print may be compared to a database of known voice prints using pattern recognition techniques. Common methods include dynamic time warping (DTW), hidden Markov models (HMM), and Gaussian mixture models (GMM). These models help in matching the input voice print with the stored templates based on the similarity of their feature vectors. Common voice prints may be stored locally in memory 108, or voice print matching may be done by another computer or network. The sound demodulation module 114 may amplify at step 412 the isolated sound signal so that it can be played back at an audible intensity. The sound demodulation module 114 may send at step 414 the sound data to the base module 110. Sound data may include the sound signal and any identified sounds, words, phrases, etc. The sound demodulation module 114 may return at step 416 to the base module 110.

FIG. 5 illustrates an example operation of the admin module 126. The admin module 126 may poll at step 500 for signal data and/or sound data from the wireless base station 102. The admin module 126 may initiate at step 502 the identification module 128 and send in the received signal data and sound data. The identification module 128 may attempt to identify a signal source and/or user. In many cases, the signal source can be identified by an IP or MAC address, but these can be hidden or changed. Further, some signal sources may not have identifying information embedded in their signal. The identification module 128 may use tracking data to estimate the positions of signal sources based on their last known position and trajectory in order to identify a new signal source as the same signal source detected earlier. The identification module 128 may use voice print data to identify the user of a user device 118. The admin module 126 may receive at step 504 identification data from the identification module 128. For example, the signal data contains signals from three sources. The first source is a new device, so a new ID is created. The second source is an existing device identified by its MAC address and IP address. The third source has no MAC address or IP address but is in the same position as a device 10 ms ago, and so is determined to be the same source. Further, the first source is associated with an existing user based on matching voice in the sound data to an existing voiceprint. The second source is already known to be a device associated with a known user. The third source's user cannot be determined and so is associated with a placeholder user until a user can be determined. The admin module 126 may determine at step 506 if the sound data contains voice data. Voice data may refer to any voice in the sound data identified by the sound recognition algorithms of the sound demodulation module 114. If there is no voice data in the sound data, the admin module 126 may skip to step 512. If there is voice data in the sound data, the admin module 126 may initiate at step 508 the voiceprint module 130 and send in the sound data. The voiceprint module 130 may generate or update a voiceprint for a user. This voiceprint can then be referenced later by the identification module 128 in order to identify a user based on their voice.

The admin module 126 may receive at step 510 voiceprint data from the voiceprint module 130. This may be a new voiceprint for a user who did not have a voiceprint before or an updated voiceprint. Since more voice data incorporated into a voiceprint often leads to a more accurate voiceprint, user voiceprints may be updated whenever that user is identified. The admin module 126 may update and/or create at step 512 entries in the user database 136 with the new data from the wireless base station 102, identification module 128, and/or voiceprint module 130. For example, if a new signal source were detected, a new entry would be created. For another example, if a voice that could not be identified were found in the sound data, a new entry would be created with a new user ID and the voiceprint generated by the voiceprint module 130. For another example, if a user is identified from their voice from sound data extracted from an unknown signal source, that signal source may be given a source ID and associated with the identified user. For another example, if a device has a new IP address but is identified by tracking data, then the new IP address may be stored in the user database 136 as the last seen IP address for that device. The admin module 126 may initiate at step 514 the action module 132 and send in the signal data, sound data, and identification data. The action module 132 may take some action based on the signal data from the signal processing module 112, sound data from the sound demodulation module 114, and identification data from the identification module 128. These sets of data are compared to the rules database 134 to determine if an action should be taken. If so, the action module 132 executes the associated actions. The admin module 126 may return at step 516 to step 500.

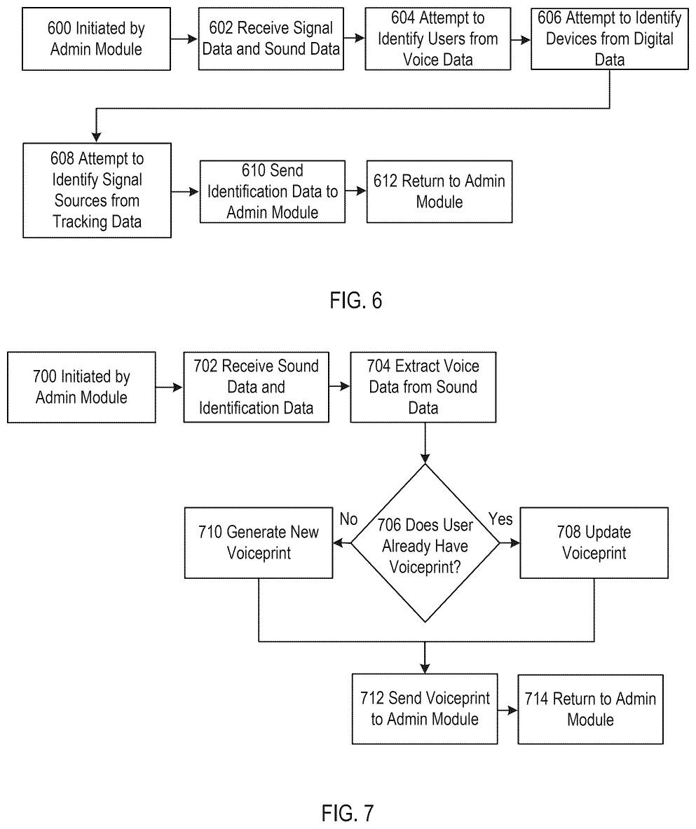

FIG. 6 illustrates an example operation of the identification module 128. The identification module 128 may be initiated at step 600 by the admin module 126. The identification module 128 may receive at step 602 signal data and sound data from the admin module 126. The identification module 128 may attempt at step 604 to identify users from voice data in the sound data. If there is no voice data in the sound data, this step may be skipped. Voice data may be analyzed and compared to known voiceprints in the user database 136. In some embodiments, voice data may be compared to one or more third-party databases containing voiceprints. Critical features of an individual's voice are extracted from the voice data. Common features include Mel-Frequency Cepstral Coefficients (MFCCs), Linear Predictive Coding (LPC) coefficients, and pitch. The critical features in the voice data may be compared to stored voiceprints in the user database 136. Similarity measures, such as cosine similarity, Euclidean distance, or more complex probabilistic methods, are used to quantify how closely the new voiceprint matches the stored ones. The identification module 128 may consider similarity over a threshold value as sufficient for identification. The results of the voice identification can be combined with visual data, radar data, SAR data, or other optical data to improve the fidelity of the results. With a positive match for voice recognition and facial recognition, there is a high likelihood of correct identification. The identification module 128 may attempt at step 606 to identify devices from digital data in the signal data. This digital data may refer to any digital information that can be extracted from the signal. This includes IP address, MAC address, device name, or any other uniquely identifying data. If any of these unique identifiers match the same identifiers stored in the user database 136, then the device can be identified. Note that identified in this context does not mean the system 100 has every detail about the device, but that the device can at least be identified as a device that has existing data in the user database 136. For example, a user brings a smartphone within range of the wireless base station 102. The MAC address and device name are received in the signal data and stored in the user database 136. The next day, the same user brings the same smartphone into range of the wireless base station 102. Because the MAC address and device name are the same, the identification module 128 is able to identify the smartphone as the same device. A user may opt to install an application on their device that sends a cryptographic ID to the wireless base station 102, identifying the device with nearly 100% certainty. The identification module 128 may attempt at step 608 to identify signal sources from tracking data. Some signal sources may not have identifying digital data or may change their unique identifiers to hide their identity. The tracking data can be used to identify these signal sources by tracking their continuous movement through space. For example, a mobile device is attempting to hide its identity by changing its unique identifiers every few minutes. However, the tracking data shows that the signal source may change its identifying information but still moves in a continuous path. Where one device appears to disconnect, another suddenly starts broadcasting different identifying information. The identification module 128 may determine that these apparently separate devices are actually the same device due to their movement along a continuous route. The identification module 128 may extrapolate from current and past tracking data to estimate the location of a signal source at some future time so that even if there is a temporary gap when the signal from the device is blocked, or the device stops broadcasting, changes identifiers, and begins broadcasting again, it can still be identified as the same device. Signal sources may also be identified by their relationship to other signal sources in the tracking data. For example, two devices, a smartphone and a smartwatch, follow a similar path in tracking data. This is likely because the same person is carrying both devices. At some later point, the smartphone is identified alongside a new unidentified device traveling in the same path. The identification module 128 may identify the new device as the smartwatch from before, based on the new device following a similar path as the smartphone. Steps 604, 606, and 608 are examples, and other methods of signal source and/or user identification may be used. For example, when not connected to a network, some devices may broadcast data containing past network connections. This data could be used to identify these devices if the system 100 had previously captured the list of past network connections. The identification module 128 may send at step 610 identification data to the admin module 126. Identification data may contain any new identifications for previously unknown devices or users and any identified features or relationships between any of the signal sources, users, and data in the user database 136. For example, the signal data contains signals from three sources. The first source is a new device, so a new ID is created. The second source is an existing device identified by its MAC address and IP address. The third source has no MAC address or IP address but is in the same position as a device 10 ms ago, and so is determined to be the same source. Further, the first source is associated with an existing user based on matching voice in the sound data to an existing voiceprint. The second source is already known to be a device associated with a known user. The third source's user cannot be determined and so is associated with a placeholder user until a user can be determined. The identification module 128 may return at step 612 to the admin module 126.

In some embodiments, a confidence metric is computed utilizing the data extracted from the signal and the sound demodulation data/vocal fingerprint which will have many sub confidence metrics, such as, but not limited, to device vendor similarity metrics, device location similarity metrics, and/or a collection of past networks. Artificial Intelligence (AI) and/or Machine Learning (ML) might be employed to maximize confidences on device ID's as well as on sub confidence levels aggregated together to create a confidence metric for the device ID.

In some embodiments, the system 100 may implement “behind-the-presence” detection to further verify people behind a device. As a non-limiting example, when an individual utilizes their phone to call a bank, the vocal fingerprint (e.g., voiceprint) the wireless base station 102 collects can be sent to the bank to verify that the person behind the phone is that person enabling the bank to not just rely on vocal data transmitted over an unsecured cellular line with no knowledge of the environment from which the caller is calling. Additionally, when accessing a bank account via a mobile application, the system 100 can keep a constant awareness of the environment and who is present in the environment so that when a person accesses their bank account via a mobile application, the bank can verify that the person's voice was detected behind the mobile phone for a particular time period (e.g., 30 seconds) before accessing the bank account via the mobile application, which enables a high confidence that the correct person is accessing the mobile application. A confidence metric can also be created not just for a device ID but also a behind-the-presence detection confidence metric that can be created separately and for environmental awareness an environmental awareness security confidence metric can be created. If, for example you, a person accesses a bank account, the sensors data might compute that the environmental awareness security confidence is low and prompt the person to use two factor authenticate or call the bank. Example aspects that might be including in the environmental awareness security confidence metric include, but are not limited to, the pattern of detected devices that are transmitting around the user, the pattern of the location and flow of movement of detected devices around the user, the user's pattern of movement, the user's conversations or statements prior to attempting to access the bank account, etc. All confidence metrics including behind-the-presence detection and environmental awareness security confidence metric might utilize AI and/or ML to maximize the level of confidence or to maximize the extraction or the understanding of data from signals, the environment or sound demodulation.

FIG. 7 illustrates an example operation of the voiceprint module 130. The voiceprint module 130 may be initiated at step 700 by the admin module 126. The voiceprint module 130 may receive at step 702 sound data and identification data from the admin module 126. The voiceprint module 130 may extract at step 704 voice data from the sound data. Extracting voice data from sound data may involve isolating the vocal component from other audio elements, such as background noise, music, or other non-vocal sounds. This process may be achieved through several techniques, each utilizing various algorithms and methodologies. Spectral subtraction reduces background noise by estimating the noise spectrum from non-speech segments and subtracting it from the speech segments, requiring the identification of periods of pure noise for an accurate noise profile. Voice activity detection (VAD) algorithms detect the presence of human speech within an audio sample by differentiating speech from non-speech segments based on energy levels, frequency content, or statistical properties, employing methods such as energy-based, zero-crossing rate, and machine learning-based VAD. Blind source separation (BSS) techniques like Independent Component Analysis (ICA) or Non-negative Matrix Factorization (NMF) separate mixed audio signals into individual sources, isolating the voice by treating it as one of the components. Deep learning models, particularly Convolutional Neural Networks (CNNs) and Recurrent Neural Networks (RNNs), have been effectively used to isolate vocals, with these models being trained on large datasets to distinguish between speech and non-speech elements, providing high accuracy in voice extraction. Beamforming, a spatial filtering technique, uses multiple microphones to enhance the voice signal coming from a specific direction while suppressing sounds from other directions, proving particularly effective in environments with directional noise sources. Adaptive filtering utilizes adaptive filters to continuously estimate and remove the noise component from the speech signal, with common adaptive filtering algorithms including the Least Mean Squares (LMS) and Recursive Least Squares (RLS) algorithms. Fourier transform techniques involve transforming the time-domain signal into the frequency domain using the Fast Fourier Transform (FFT), allowing the application of various filtering techniques to isolate the frequency bands corresponding to human speech. Each technique may have its own advantages and limitations depending on the specific application and the characteristics of the sound sample, and the voice print module 130 may combine multiple techniques to extract the vocal component from the sound data. The voiceprint module 130 may determine at step 706 if the user already has a voiceprint in the user database 136. Users may be identified by matching their voice in the sound data to a voiceprint. Therefore, if the user already has a voiceprint in the system 100, the identification data may indicate that the voiceprint identified them. If the user was identified without using a voiceprint, the voiceprint module 130 may check the user database 136 to see if there is an existing voiceprint associated with the identified user. If the user already has a voiceprint, the voiceprint module 130 may update at step 708 the existing voiceprint. Updating an existing voiceprint with new voice data may involve integrating the new data to refine and improve the accuracy of the voiceprint. This process can be done using several methods, depending on the underlying model used to create the voiceprint. The voiceprint module 130 may extract features from the new voice data using the same methods as the original voiceprint. Common features include Mel-Frequency Cepstral Coefficients (MFCCs), Linear Predictive Coding (LPC) coefficients, and pitch-related features. Ensuring the feature extraction process is consistent is crucial for accurate updating. These features may then be integrated into the existing voiceprint. This may be done by regenerating the original voiceprint with the new feature data included. Alternatively, the new features may be averaged with the original features, which may be a weighted average. This may create a recency bias in the voiceprint data, which may better capture the user's voiceprint as the user's voice changes over time. If the user does not have a voiceprint, the voiceprint module 130 may generate at step 710 a voiceprint for the user based on the extracted voice data. Generating a voiceprint from extracted voice data may involve creating a unique biometric representation of the user's voice. Common features for voiceprints are Mel-Frequency Cepstral Coefficients (MFCCs). MFCCs represent the short-term power spectrum of a sound. They are derived from a Fourier transform of the audio signal, followed by a mapping onto the Mel scale, which approximates the human ear's response to different frequencies. This process typically involves framing the audio signal into short time windows, applying a Hamming window to minimize spectral leakage, and computing the Fourier transform for each frame. The logarithm of the power spectrum is then taken, and a Discrete Cosine Transform (DCT) is applied to obtain the MFCCs. In addition to MFCCs, other features such as Linear Predictive Coding (LPC) coefficients, pitch, formants, and dynamic features like delta and delta-delta coefficients can be extracted to capture the temporal variations in the voice signal. The voiceprint module 130 may create a voiceprint by modeling the statistical distribution of these features. Gaussian Mixture Models (GMMs) may be used for this purpose, where the parameters of the GMM represent the voiceprint. The training process involves estimating the mean, covariance, and mixture weights of the GMM using techniques such as the Expectation-Maximization (EM) algorithm. Deep learning approaches, particularly using architectures like Convolutional Neural Networks (CNNs) and Recurrent Neural Networks (RNNs), may also be utilized in generating voiceprints. These models may learn complex representations directly from the raw audio or feature vectors, providing enhanced accuracy and robustness. The neural network may be trained on a large dataset of voice samples, learning to map the input features to a high-dimensional embedding space, where each speaker's voiceprint is represented as a unique vector. The voiceprint module 130 may send at step 712 the generated or updated voiceprint to the admin module 126. The voiceprint module 130 may return at step 714 to the admin module 126.

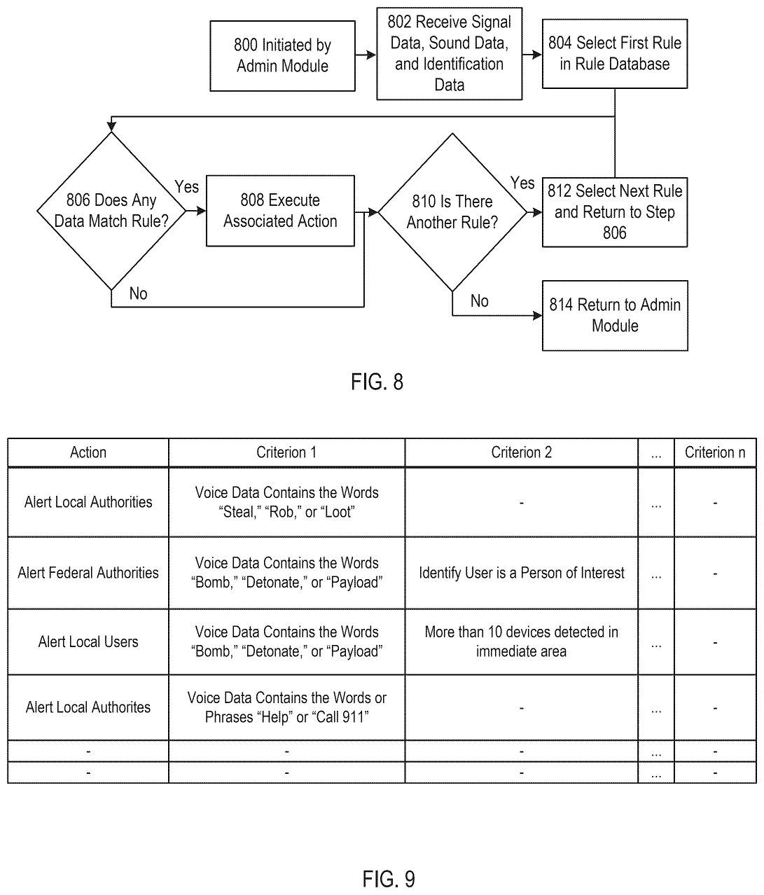

FIG. 8 illustrates an example operation of the action module 132. The action module 132 may be initiated at step 800 by the admin module 126. The action module 132 may receive at step 802 signal data, sound data, and identification data from the admin module 126. The action module 132 may select at step 804 the first rule in the rules database 134. First may refer to the rule that appears first in the database, the rule with the highest urgency. This rule is most likely to be matched, the rule that is easiest to evaluate, or any other method of organizing which rule is selected first. The action module 132 may determine at step 806 if any data matches the selected rule. Data may match if it meets the requirements of the criterion or criteria associated with the rule. For example, if a rule requires at least 10 signal sources to be in the signal data, the action module 132 may determine the number of unique signal sources in the signal data. If that number is 12, then the criterion is met since 12 is at least 10. A rule may require multiple criteria to be met before the data is considered matching. For example, a rule may require that the identified user has spoken the words “call 911” and that data in the user database 136 indicates the user is elderly. While the first criterion may trigger an action to call a 911 operator, the addition of the second criterion may trigger a different rule, which requires an ambulance to be dispatched immediately. The criteria associated with the rules may use any parameters, data, or other information available to the system 100. This can be information in the signal data, sound data, identification data, user database 136, or any other data available to the system 100, such as time and date, weather, GPS location, traffic data, etc. If the rule does not match the data, the action module 132 may skip to step 810. If the data matches the selected rule, the action module 132 may execute at step 808 the associated action. For example, a rule may require that local police be sent an alert, which may also contain the extracted voice data. The nature of the action to be taken is based on the purpose of the rule and the associated criteria. For example, an action to alert federal authorities may be associated with a rule intended to catch terrorist threats, and the criteria for triggering the action may involve voice data that includes words like “Bomb” or “Detonate.” If the action module 132 lacks the capability to execute the action, it may notify or initiate other software or hardware that can. The action module 132 may determine at step 810 if there is another rule in the rules database 134 that has not yet been selected. If there is another rule, the action module 132 may select at step 812 the next rule and return to step 806. If all rules have been selected, the action module 132 may return at step 814 to the admin module 126.

FIG. 9 illustrates an example of the rules database 134. The rules database 134 may contain rules on when the action module 132 should execute an action. Each rule may contain parameters pertaining to the features of the signal data, sounds or words extracted from the sound data, and/or the identity of the signal source and/or user. For example, words such as “Bomb,” “Detonate,” or “Payload” are detected in the voice data. The speaker of the words is identified as a person of interest by an organization such as the FBI or CIA. The speaker may be identified by comparing the voice data to match the voice print of the individual. The matching voiceprint in the user database 136 may be associated with a user. That user may also be associated with user data that includes their status as a person of interest. These circumstances match a rule that requires federal authorities to be alerted of a possible explosive threat. Note that even though there may be another rule in the database that also includes “Bomb,” “Detonate,” or “Payload” in the voice data as a criterion, that rule may also include a second criterion, such as 10 nearby devices, which is not met. At least one criterion is associated with each required action. One or all of the criteria must be met for the action module 132 to take the associated action in some embodiments. A set of parameters in the data may cause multiple actions so long as the criteria for those actions are met. Some rules may require a multistep process, wherein the first rule causes a second rule to become active. For example, a user making a phone call to a bank or credit card company may be asked to give their name. Once the name is given, this may trigger the first rule, which may cause the action module 132 to search the user database for the spoken name. The action module 132 may then determine if the person speaking matches the voiceprint associated with the spoken name. If the person speaking's voice does not match the voiceprint associated with the spoken name, then an alert may be sent to the bank or credit card company. If the person speaking's voice does match the voiceprint, then a voice verification notification may be sent to the bank or credit card company instead.

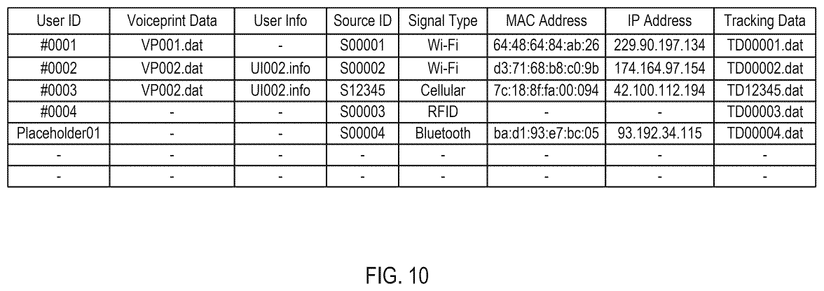

FIG. 10 illustrates an example of the user database 136. The user database 136 may contain data specific to each user. Users may refer to any person for whom the system 100 has generated a voiceprint or any person whose identity is associated with a signal source. The data in the user database 136 may include the user's voiceprint, associated user device 118, any signal source where the user's voice was detected, personal data on the user, or any other data specific to a user. In some cases, the system 100 may have further information about a user, such as name, age, search history, etc. Not all data fields in the user database 136 may be filled, as information on users and signal sources may be collected in pieces and reconstructed through associations. When a signal source cannot be associated with a user, a placeholder user ID may be assigned until more data can be gathered. Additional data may be stored in the user database 136 other than the data shown in the figure. For example, signal frequency data, other identified sound data such as music or common noises, geolocation data, encryption type data, web search data, signal modulation data, or any other type of data which may assist the system 100 in identifying a user, signal source, or both.

The functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

What is claimed is:

1. A system comprising:
a phased antenna array configured to receive signals from at least one signal source, wherein the received signals include noise caused, at least in part, by sound waves near the at least one signal source;
a signal processor configured to locate the at least one signal source in three-dimensional (3D) space using the received signals;
a sound demodulator configured to demodulate the noise in the received signals caused by sound waves near the at least one signal source to produce sound data; and
at least one processor configured to:
identify at least one user from voice data extracted from the sound data and/or at least one device associated with the at least one signal source to produce identification data; and
in response to the received signals, the sound data and/or the identification data satisfying one or more rules in a rule database, execute an action associated with the one or more rules.

2. The system of claim 1, wherein the phased antenna array is configured to initially send a ping signal to the at least one signal source.

3. The system of claim 1, wherein the at least one signal source includes one or more of a vibration detector, a passive tag, and/or a user device.

4. The system of claim 3, wherein the vibration detector actively transmits the signals to the phased antenna array without being pinged by the phased antenna array.

5. The system of claim 1, wherein the system operates in an active and/or a passive mode, such that, in the passive mode, radio waves that naturally occur without prompting or responding emanate from the at least one signal source, and, in the active mode, the phased antenna array is configured to transmit radio waves that are reflected or retransmitted by the at least one signal source to create a larger sample of data for sound demodulation.

6. The system of claim 1, wherein the at least one processor is configured to identify the at least one device by combining the sound data with data extracted from the received signals, wherein the data extracted from the received signals includes one or more of Media Access Control (MAC) addresses, device names, Internet Protocol (IP) addresses, Service Set Identifiers (SSIDs), network names of all previously connected SSIDs, SSID lengths of all previously connected SSIDs, currently connected SSID, SSID length of currently connected SSID, supported link speeds, supported ciphers or cryptographic capabilities, high throughput capabilities (HT), Aggregated MAC Protocol Data Unit (AMPDU) data, vendor specific capabilities, timestamps for when a probe request was received, signal strengths, signal levels, noise ratios, and/or vendor information.

7. The system of claim 6, wherein the at least one processor executes an Artificial Intelligence (AI) and/or Machine Learning (ML) system to extract the data from the received signals and/or identify the at least one device using the data extracted from the received signals.

8. The system of claim 1, wherein the at least one processor is further configured to calculate a confidence metric utilizing the data extracted from at least one signal and the sound data for use in identifying the at least one device.

9. The system of claim 8, wherein the confidence metric includes a plurality of sub-confidence metrics.

10. The system of claim 9, wherein the plurality of sub-confidence metrics include one or more of device vendor similarity metrics, device location similarity metrics, and/or a collection of past networks.

11. The system of claim 1, wherein the at least one processor is further configured to generate at least one voiceprint from the sound data.

12. The system of claim 11, wherein at least one processor is further configured to use the at least one voiceprint to perform behind-the-presence detection and identification.

13. The system of claim 12, wherein the behind-the-presence detection identifies not only the at least one device but user of the at least one device.

14. The system of claim 1, wherein the signal processor is configured to locate the at least one signal source using at least one of an Angle of Arrival (AoA) measurement, a Kalman filter, a Joint Probabilistic Data Association (JPDA) operation, and/or a Multiple Signal Classification (MUSIC) algorithm.

15. The system of claim 1, wherein the signal processor is configured to locate the at least one signal source by triangulation and/or trilateration.

16. The system of claim 1, wherein the one or more rules in the rule database are ordered according to an urgency level and processed in order of the urgency level.

17. The system of claim 1, wherein at least one of the one or more rules include multiple criteria that must be satisfied in order to execute the associated action.

18. The system of claim 1, wherein at least one rule of the one or more rules specifies that at least one particular word is found in the voice data.

19. The system of claim 1, wherein at least one rule of the one or more rules specifies that an identified user is found in a particular list of users.

20. The system of claim 1, wherein at least one rule of the one or more rules specifies that at least a particular number of devices are detected in a particular area.

21. A method comprising:
receiving signals, via a phased antenna array, from at least one signal source, wherein the received signals include noise caused, at least in part, by sound waves near the at least one signal source;
locating, via a signal processor, the at least one signal source in three-dimensional (3D) space using the received signals;
demodulating the noise in the received signals caused by sound waves near the at least one signal source to produce sound data;
identifying at least one user from voice data extracted from the sound data and/or at least one device associated with the at least one signal source to produce identification data; and
in response to the received signals, the sound data and/or the identification data satisfying one or more rules in a rule database, executing an action associated with the one or more rules.

22. The method of claim 21, further comprising an initial step of sending, via the phased antenna array, a ping signal to the at least one signal source.

23. The method of claim 21, wherein the at least one signal source includes one or more of a vibration detector, a passive tag, and/or a user device.

24. The method of claim 23, wherein the vibration detector actively transmits the signals to the phased antenna array without being pinged by the phased antenna array.

25. The method of claim 21, wherein locating includes locating the at least one signal source using at least one of an Angle of Arrival (AoA) measurement, a Kalman filter, a Joint Probabilistic Data Association (JPDA) operation, and/or a Multiple Signal Classification (MUSIC) algorithm.

26. The method of claim 21, wherein locating includes locating the at least one signal source by triangulation and/or trilateration.

27. The method of claim 21, further comprising:
ordering the one or more rules in the rule database according to an urgency level; and
processing the one or more rules in order of the urgency level.

28. The method of claim 21, wherein at least one of the one or more rules include multiple criteria that must be satisfied in order to execute the associated action.

29. The method of claim 21, wherein at least one rule of the one or more rules specifies that at least one particular word is found in the voice data.

30. The method of claim 21, wherein at least one rule of the one or more rules specifies that:
an identified user is found in a particular list of users; or
at least a particular number of devices are detected in a particular area.
